(19) United States
(12) Patent Application Publication
(10) Pub. No.: US 2019/0236121 A1
(43) Pub. Date: Aug. 1, 2019

(54) VIRTUALIZED DETAIL PANEL

(71) Applicant: salesforce.com, inc., San Francisco, CA (US)

(72) Inventors: Alicia Ong, San Mateo, CA (US); Anjali Ashok, San Francisco, CA (US)

(73) Assignee: salesforce.com, inc., San Francisco, CA (US)

(21) Appl. No.: 15/882,673

(22) Filed: Jan. 29, 2018

(51) Int. Cl. G06F 17/22; G06F 17/27; G06F 8/38; G06F 17/24

(52) U.S. Cl. CPC G06F 17/2247; G06F 17/24; G06F 8/38; G06F 17/2765

(57) ABSTRACT

A method for efficiently generating a detail panel has been developed. First, a detail panel that contains a list of multiple items is accessed by a user. An initial component is created by populating initial items with data in a text language format. Subsequent items are also populated with data in a text language format to create a subsequent component. The text language of the initial component is compared to the text language of the subsequent components. If the initial component is similar enough to exceed a predetermined compatibility threshold, the initial component is used as a substitute for the subsequent components.

### TECHNICAL FIELD

Embodiments of the subject matter described herein relate generally to webpage generation. More particularly, embodiments of the subject matter relate to a virtualized detail panel.

### BACKGROUND

As graphics and data become more complex for various types of computer generated pages, the loading and generation time for each of these pages becomes longer. It is clearly advantageous to optimize the loading time for pages for a user. Accordingly, it is desirable to provide a virtualized detail panel for webpage. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a flowchart of a method for providing a virtualized detail panel in accordance with one embodiment;

FIG. 2 is a block diagram of an initial component and a subsequent component in accordance with one embodiment; and

FIGS. 3A and 3B are comparison pie charts demonstrating improved loading times for a virtualized detail panel in accordance with one embodiment.

### DETAILED DESCRIPTION

A method and system for efficiently generating a detail panel has been developed. A “detail panel” is a software interface that is developed and organized by a customer. A detail panel is made up of a separate and distinct “items” which are populated with data. The data is typically in a text language format. Multiple items are combined and used to create a component. “Components” are self-contained, reusable units of an application. The component may contain a single line of text all the way to an entire application. A user may use an “in-line editing” function to quickly edit field values and other characteristics of the items and components.

A page of a detail panel is formed in a layout which is a responsive grid system for arranging the contents of the page. Generation of a layout of a page typically involves the tasks of scripting, rendering, painting and other tasks for the page. “Scripting” involves executing commands contained within a file. “Rendering” involves processing the work (e.g., interpreting text language) of a component. Some embodiments of the present invention involve rendering pages by providing a “virtualization” of the lists and items for the detail panels. The process of virtualization involves the creation of a single component and applying it several times. Ideally, this avoids having to repeat the creation of each component thus saving time in the generation of the detail panel. This can be accomplished by identifying repeating items that are very similar or close to a previously created component and applying the previously generated component in lieu of creation the new component.

In some embodiments, the items of the components use a hypertext markup language format (HTML). If the text of different components is similar enough among different components, the previously generated component may be reused. In other embodiments, the structure of the components may be compared in addition to of the comparison of the text. In some embodiments, a threshold of 50% similarity may be used to determine if a component may be substituted. Ultimately, the decision on substitution is a cost analysis comparing the cost in time of creating two components versus the cost in time of using a virtualized component. In other embodiments, the user may manually decide on the virtualized component or in the decision process may be automated. Additionally, a user may adjust the similarity threshold used based on their preference.

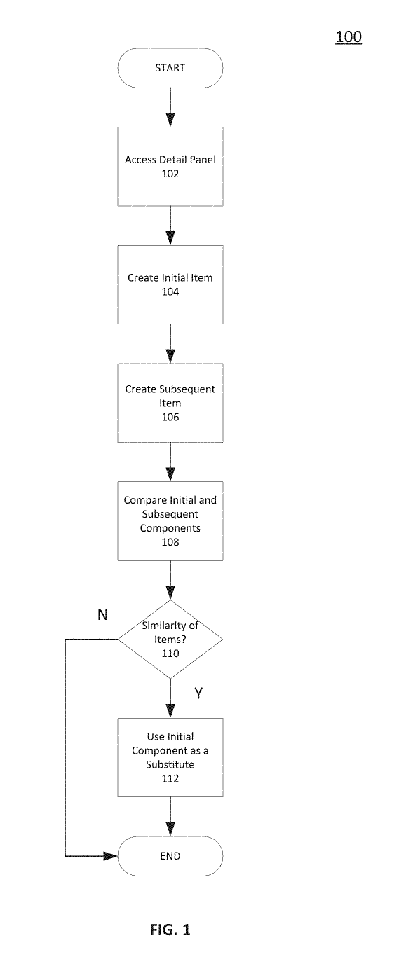

Turning now to FIG. 1, a flowchart 100 of a method for providing a virtualized detail panel in accordance with one embodiment is shown. First, a detail panel that is stored in a retrievable database system is accessed by user 102. The detail panel comprises at least one list of multiple items. An initial item is created 104 by populating it with data in a text language format. The initial item is used to create an initial component. A subsequent item is also created 106 by populating it with data in a text language format. The subsequent item is used to create a subsequent component. The text language content of the initial and subsequent components are compared 108 to determine the degree of similarity between the two. If the similarity between the initial and subsequent component exceeds a predetermined compatibility threshold 110, the initial component is used as a substitute for the subsequent component 112.

In some embodiments, the text language format used is a standard general markup language (SGML). The SGML may be: hypertext markup language (HTML); extensible markup language (XML); extensible hypertext markup language (XHTML); or other suitable text language formats. Additionally, the initial and subsequent items may be populated with data using JavaScript language. In other embodiments, the predetermined compatibility threshold used to compare the initial and subsequent components is manually set by the user. In other embodiments, the predetermined compatibility threshold is automatically set. In some examples, the compatibility threshold may be set to a value of at least 50% similarity between the text language of the components to allow substitution.

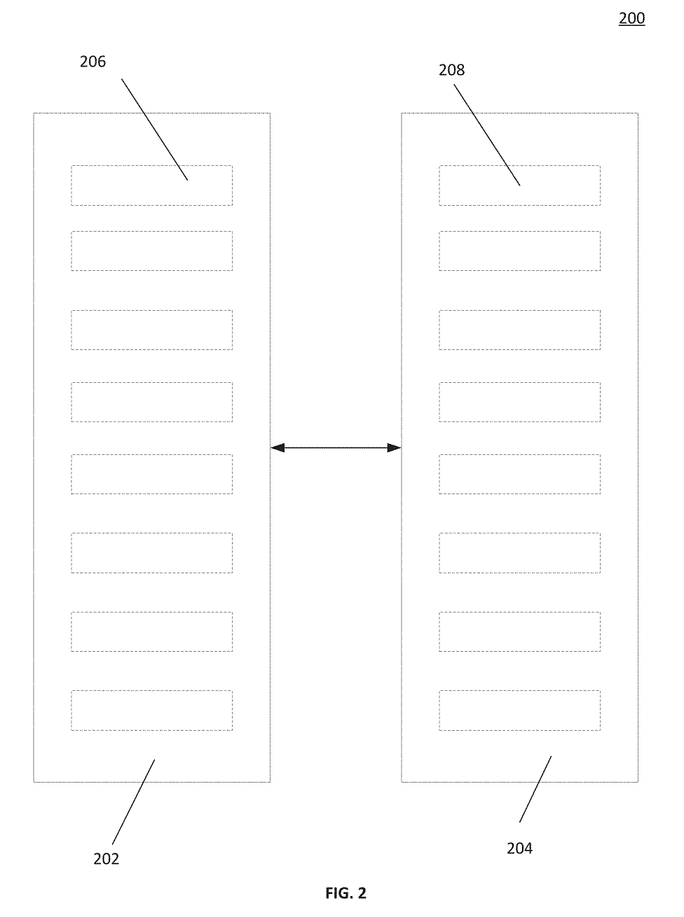

Turning now to FIG. 2, a block diagram 200 is shown of an initial component and the subsequent component in accordance with one embodiment. The initial component 202 is populated with multiple initial items 206. The subsequent component 204 is also populated with multiple subsequent items 208. Both of the initial items 206 and the subsequent items 208 are populated with data in a text language format provided by the user. These items 206 and 208 are used to create their respective components 202 and 204. Embodiments will compare the content of the text language of the initial component 202 with the subsequent component 204 to determine the level of compatibility. If the level of compatibility exceeds a predetermined threshold, substitution of the initial component 202 for the subsequent component 204 is allowed. This avoids using additional time to create the subsequent component 204.

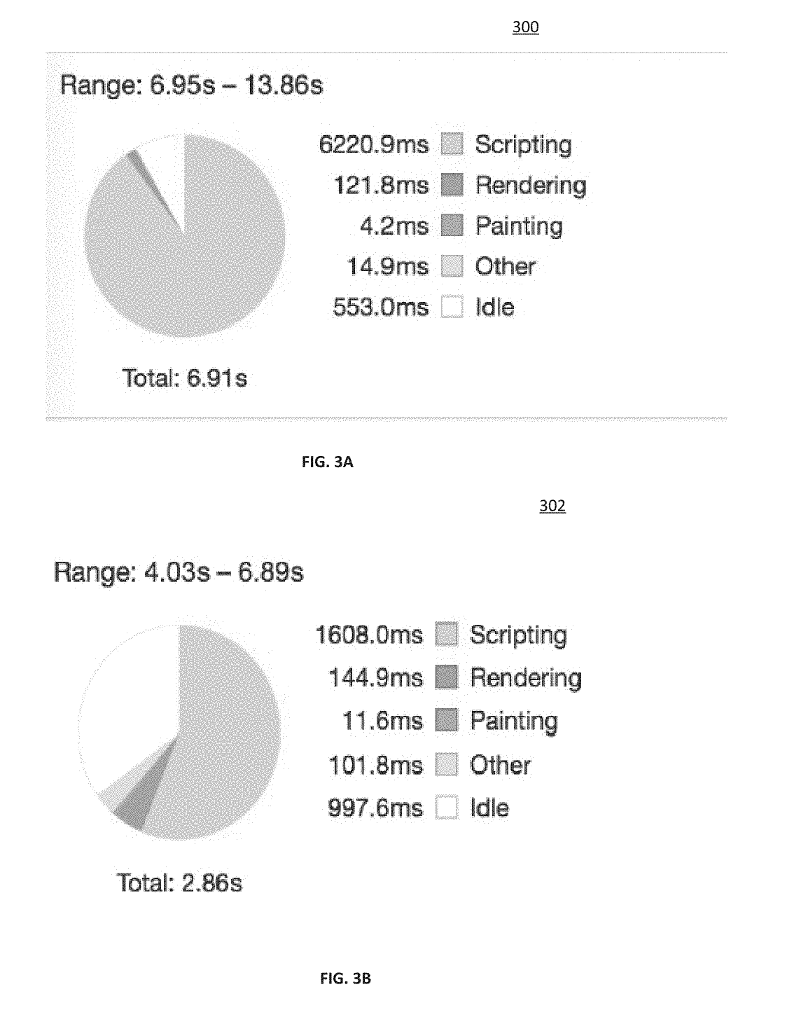

Turning now to FIGS. 3A and 3B, comparison pie charts 300 and 302 are shown demonstrating improved creation times for a virtualized detail panel in accordance with one embodiment. Specifically, FIG. 3A shows a pie chart of the creation time for a detail panel that does not use one of the present embodiments. The time required for creation falls within a range of 6.95 sec.-13.86 sec. In this example, 6220.9 msec. are used for scripting during the creation. This is by far the greatest portion of time used in this example. Additionally, 121.8 msec. are used for rendering. In contrast, FIG. 3B shows a pie chart 302 of the creation of a detail panel using the virtualization process in accordance with one embodiment. In this example, the process is completed within a range of 4.03 sec-6.89 sec. By comparison, the scripting time has been reduced to 1608.0 msec. However, the rendering time has been increased to 144.9 msec. Nevertheless, the overall time for creation of the page using the virtualization process is significantly reduced. This provides a clear advantage by using virtualization to create one component and applying it multiple times if it meets a predetermined compatibility threshold as previously described.

It would be advantageous to analyze the images posted across a data group to identify points of interest and detect positive usage trends across groups. Embodiments of the subject matter described herein generally relate to techniques for processing and analysis of posted online images. More particularly, embodiments of the subject matter relate to identifying positive usage trends based on analysis of posted online images. The disclosed embodiments described below may be implemented in a wide variety of different computer-based systems, architectures and platforms which may include a multi-tenant system. Additionally, the disclosed embodiments may be implemented using mobile devices, smart wearable devices, virtual systems, etc.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematics depict one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with the disclosed process may be performed by software, hardware, firmware, or any combination thereof. In practice, portions of the process may be performed by different elements of the described system, e.g., component A, component B, or component C. It should be appreciated that the process may include any number of additional or alternative tasks, the tasks shown need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for efficiently generating a detail panel, comprising:
accessing a detail panel stored on a retrievable database system by a user, where the detail panel comprises at least one list of multiple items;
populating of an initial item with data in a text language format from the user to create an initial component;
populating a subsequent item with data in a text language format from the user to create a subsequent component;
determining if the initial component is similar in content to a subsequent component by comparing the text language of the initial component to the text language of the subsequent component; and
using the initial component as a substitute for the subsequent component in the list of multiple items if the similarity between the initial component and the subsequent component exceeds a predetermined compatibility threshold.

2. The method of claim 1, where the text language format comprises a standard general markup language (SGML).

3. The method of claim 2, where the SGML is hypertext markup language (HTML).

4. The method of claim 2, where the SGML is extensible markup language (XML).

5. The method of claim 2, where the SGML is extensible hypertext markup language (XHTML).

6. The method of claim 1, where the predetermined compatibility threshold is manually set by the user.

7. The method of claim 1, where the predetermined compatibility threshold is automatically set.

8. The method of claim 1, where the predetermined compatibility threshold comprises at least 50% similarity between the text language of the initial component and the text language of the subsequent component.

9. The method of claim 1, where the initial and subsequent items are populated with data using JavaScript language.

10. A system for efficiently generating a detail panel comprising:
a database to store a detail panel comprising at least one list of multiple items; and
a computing device coupled to the database to loaded with software instructions causing the computing device to implement,
populating of an initial item with data in a text language format from the user to create an initial component,
populating a subsequent item with data in a text language format from the user to create a subsequent component,
determining if the initial component is similar in content to a subsequent component by comparing the text language of the initial component to the text language of the subsequent component, and
using the initial component as a substitute for the subsequent component in the list of multiple items if the similarity between the initial component and the subsequent component exceeds a predetermined compatibility threshold.

11. The system of claim 9, where the text language format comprises a standard general markup language (SGML).

12. The system of claim 9, where the SGML is hypertext markup language (HTML).

13. The system of claim 9, where the SGML is extensible markup language (XML).

14. The system of claim 9, where the SGML is extensible hypertext markup language (XHTML).

15. The system of claim 9, where the predetermined compatibility threshold is manually set by the user.

16. The system of claim 9, where the predetermined compatibility threshold is automatically set.

17. The system of claim 9, where the predetermined compatibility threshold comprises at least 50% similarity between the text language of the initial component and the text language of the subsequent component.

18. The system of claim 9, where the initial and subsequent items are populated with data using JavaScript language.
